(19) United States
(12) Patent Application Publication
(10) Pub. No.: US 2015/0066696 A1
(43) Pub. Date: Mar. 5, 2015

(54) COORDINATION OF BUSINESS SYSTEMS

(71) Applicants: Verizon Deutschland GmbH, Arlington, VA (US); Verizon Patent and Licensing Inc., Arlington, VA (US)

(72) Inventors: Peter Teuber, Nachrodt-Wiblingwerde (DE); Frederick Winter, Denver, CO (US); Krishnakumar N Iyer, Cedar Rapids, IA (US)

(73) Assignees: VERIZON DEUTSCHLAND GMBH, Arlington, VA (US); VERIZON PATENT AND LICENSING INC., Arlington, VA (US)

(21) Appl. No.: 14/018,321

(22) Filed: Sep. 4, 2013

(51) Int. Cl. G06Q 30/06; G06Q 50/18

(52) U.S. Cl. CPC G06Q 30/0613; G06Q 50/18; G06Q 30/0635
USPC 705/26.41

(57) ABSTRACT

Techniques described herein may provide for end-to-end integration of business systems used in the sale and fulfillment flow for products provided by a business. In one implementation, a method may include receiving a request for a contract relating to products and services offered by a business; and transmitting a message, to one or more workers, indicating that the one or more first workers are to generate the contract. The method may further include receiving the generated contract from the one or more workers; transmitting, in response to reception of a signed version of the contract, a message initiating order fulfillment for the products and services to which the contract relates; determining, as part of the order fulfillment, a plurality of work orders corresponding to the products and services to which the contract relates, and issuing the plurality of work orders to a plurality of provisioning departments of the business.

### BACKGROUND

Large corporations, or other entities that offer a relatively complex set of products and services, may develop a complex set of business systems to handle the various aspects of selling the products/services, providing price quotes relating to the products/services, contract creation, order management, provisioning of the products/services, and billing for the products/services. In the process of the sale of a product/service to a particular customer, a number of workers may be involved in the sale and fulfillment of the product/service. Each worker may be assigned a role in the process, such as a worker to review the sales contact, a pricing approval manager, a customer approval manager, a billing specialist, a provisioning technician, etc. As part of fulfillment of his or her role, each worker may access information from one or more business systems, complete one or more forms, and make decisions and/or perform actions relating to the product/service.

For complex products and services, such as products that are sold with services or products with which availability can vary based on geography or other factors (e.g., network access), the interoperability of the various business systems involved in the sale and fulfillment of the products and services can be complex.

### BRIEF DESCRIPTION OF THE DRAWINGS

FIG. 1 is a diagram conceptually illustrating an example of an overview of concepts described herein;

FIG. 2 is a diagram conceptually illustrating an example of a set of business systems, which may correspond to business systems that are used in the sale and fulfillment of products;

FIG. 3 is a diagram conceptually illustrating an example of relationships of elements used in the modeling of products in a product catalog system;

FIG. 4 is a block diagram conceptually illustrating an example of components of a provisioning system;

FIG. 5 is a flow chart illustrating an example of a process that may be performed to coordinate the operation of business systems;

FIG. 6 is a diagram conceptually illustrating an example of communications between various systems of a business system;

FIG. 7 is a flow chart illustrating an example of a process that may performed by an order management system;

FIG. 8 is a flow chart illustrating an example of a process that may performed by a provisioning system; and

FIG. 9 is a diagram of example components of a device.

### DETAILED DESCRIPTION OF PREFERRED EMBODIMENTS

The following detailed description refers to the accompanying drawings. The same reference numbers in different drawings may identify the same or similar elements.

Aspects described herein will be described in relation to products and services that are provided by a business. For clarity, the term products, as used herein, may refer to products and/or services provided by a business.

Techniques described herein may provide for end-to-end integration of business systems used in the sale and fulfillment flow for products provided by a business. The business systems may be distributed and operated independently of one another. Tasks relating to the sale and fulfillment of products may be generated automatically and in response to worker input or intra-system messages. Workers may only need to know their individual role, and do not necessarily need to know the overall sales/fulfillment flow. Information relating to a particular worker, at a particular step in the sales/fulfillment flow, may be automatically populated for the worker. Accordingly, worker rekeying of data at the various sales/fulfillment operations may be reduced relative to traditional business systems that are not integrated in the manner described herein. In general, workers can quickly make decisions with respect to their respective roles, which may increase the overall efficiency of the sales/fulfillment flow.

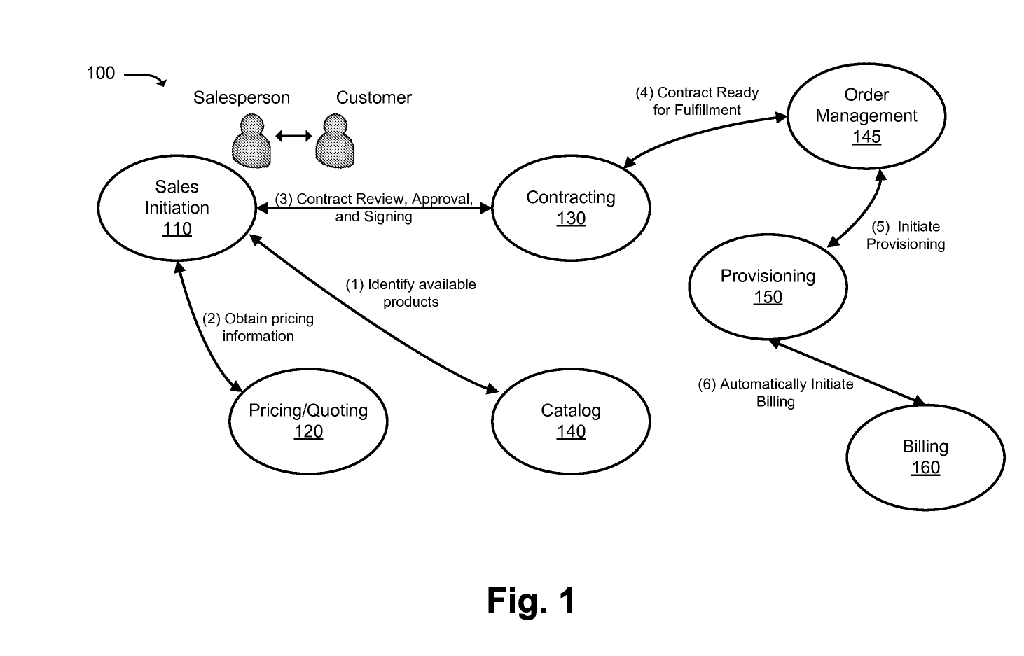

FIG. 1 is a diagram conceptually illustrating an example of an overview of concepts described herein. A set of business systems 100, which may correspond to business systems that are used in the sale and fulfillment of products, are illustrated in FIG. 1. The illustrated set of business systems include: sales initiation 110, pricing/quoting 120, contracting 130, catalog 140, order management 145, provisioning 150, and billing 160.

Each of business systems 110-160 may represent one or more servers or processes that are used in the sale and fulfillment of products by a particular business. For example, business systems 110-160 may each include a set of custom applications, off-the-shelf applications, and/or business logic/rules that may be used by the particular business.

Each of business systems 110-160 may include logic to respond to messages and/or worker input, which may initiate different stages of approval, analysis, and provisioning, that may occur during the sale and fulfillment of a customer order. For example, sales initiation system 110 may include customer relationship management software to help model the interaction of a business with current and future customers. Salespeople, associated with the business, may use sales initiation system 110 to initiate sales opportunities and to submit product quotes and view available products and services.

Price/quoting system 120 may include logic to automatically determine prices, or a range of potential prices, for a particular combination of potential products. Prices determined by price/quoting system 120 may be based on a number of business rules and/or models that allow for the pricing of complex combinations. In some implementations, for some products, workers associated with price/quoting system 120 may be required to manually approve final pricing for high value sales, for sales in which a salesperson wishes to offer a discount, or in other situations. In general, the price for a complex combination of products may vary based on a number of factors, such as the length of the potential service contract, the credit worthiness of the potential customer, the geographical area in which the services are being provided, and/or other factors. Price/quoting system 120 may include a number of rules and models that take these factors into account.

Catalog system 140 may include a centralized catalog of products offered by the business. The products may be modeled using a standardized interface that allows the products to be automatically accessed and priced in a consistent manner and in which limitations on particular products, such as geographical limitations, can be automatically taken into account. Because of the standardized interface used by catalog system 140, other business systems, in the set of business systems 100, may be able to automatically interact with catalog system 140.

Contracting system 130 may include logic to receive contracts from salespeople, store the contracts, and facilitate the review and approval of contracts by workers associated with the business (e.g., by personnel in the legal department). Provisioning system 150 may include logic to schedule and manage provisioning of the products and services corresponding to a particular sale. In some situations, certain activities of provisioning system 150, such as the activation of network links for a particular customer, may be handled automatically by provisioning system 150. Other services, such as the physical installation of network equipment, may be automatically scheduled, for workers associated with the business, by provisioning system 150. Billing system 160 may include logic to implement billing associated with a contract. Depending on the terms of the contract relating to the sale, billing system 160 may track payments made by the customer, generate invoices for the customer, and perform other billing-related activities that are related to the contract.

Order management system 145 may include logic to perform operations relating to initiation of fulfillment of the products associated with the contract. For example, order management system 240 may present the agreed-upon products, associated with the contract, to an account manager, who may review and initiate the order(s) relating to the products.

As an example of the operation of the set of business systems 100, consider a salesperson that is negotiating a sale with a potential customer. The salesperson may use sales initiation system 110 to track sales leads to obtain an audience with the potential customer. While at the customer site, the salesperson may interact with catalog system 140 to obtain a catalog of the various products and services that are available for the particular customer (illustrated as communication (1) in FIG. 1). The customer may express interest in some of the available products or services.

The salesperson may immediately obtain estimated pricing for products in which the potential customer is interested (communication (2)). The pricing information may include, for example, a range of prices that the salesman is authorized to provide to the potential customer. The range of prices may be customized based on factors such as the geographic location of the potential customer, information relating to the potential customer (e.g., information relating to the size and/or credit worthiness of the potential customer, as obtained from sales initiation system 110), sales trends of the business, and/or other factors. Thus, prices may be dynamically determined for products, instead of products each having set prices.

When the salesperson and the potential customer have preliminarily agreed on a sale, the salesperson may initiate, via contracting system 130, review and contract creation for the sale (communication (3)). For example, contracting system 130 may automatically generate an initial draft of an appropriate contract, which may be reviewed and approved by a worker, and automatically sent back to the salesman for presentation to the customer. When the customer signs the contract, the salesperson may upload the contract to contracting system 130 for final signature of the contract. Final approval of the contract may automatically trigger, by order management system 145, fulfillment of the products and/or services related to the contract. For example, the contract may be automatically provided to order management system 145 (communication (4)), where the contract may be reviewed and converted into actions need to fulfill the contract. Orders corresponding to the contract may then be provided to provisioning system 150, for provisioning and/or delivery of services and products related to the contract (communication (5)). Similarly, provisioning and/or delivery of the services and products may automatically trigger, at billing system 160, billing of the customer (communication (6)).

The communication flow illustrated in FIG. 1 may, in some implementations, be triggered based on automatic triggers associated with business systems 110-160. Forms and/or information required by workers, associated with business systems 110-160, may, to the extent possible, be automatically completed and presented to the worker in a manner that allows the responsible worker to quickly evaluate and make decisions. In this manner, the sale and fulfillment of products, even for relatively complex product offerings, may be performed efficiently and accurately by a business.

Although the term “business” is used herein to refer to an entity that operates business system 100, in general, “business” may refer to any entity that provides products using a number of business systems.

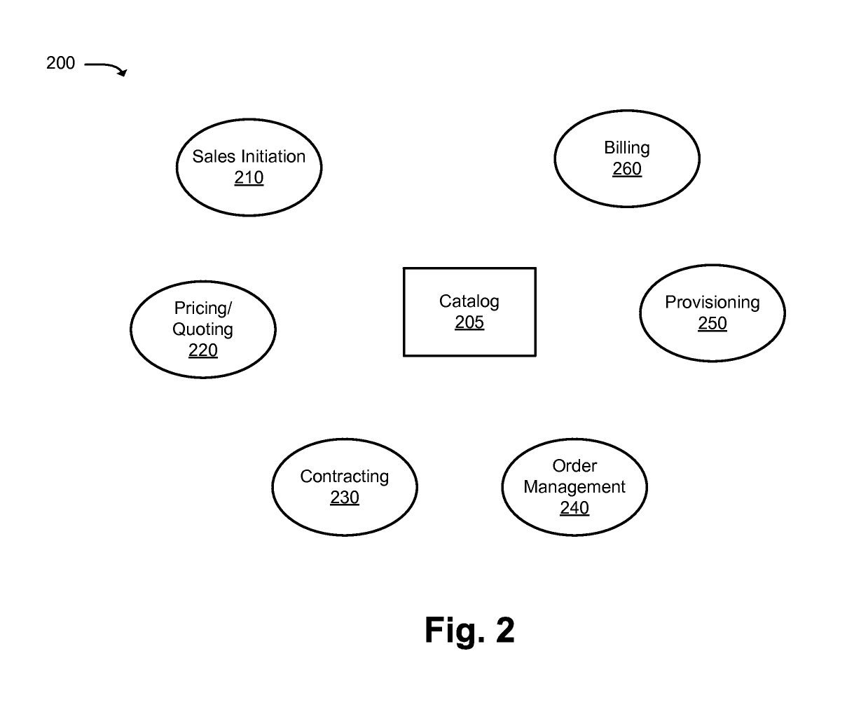

FIG. 2 is a diagram conceptually illustrating an example of a set of business systems 200, which may correspond to business systems that are used in the sale and fulfillment of products. Business systems 200 may generally correspond to a more detailed version of the business systems shown in FIG. 1. As illustrated, business systems 200 may include: catalog system 205, sales initiation system 210, pricing/quoting system 220, contracting system 230, order management system 240, provisioning system 250, and billing system 260. Each business system 210-260 may correspond to, for example, one or more computing devices, which may be physically co-located or distributed, that provide logic to respond to messages and/or worker input, and may include business rules and/or models to perform functions relating to the sales/fulfillment flow of a business. Business systems 210-260 may communicate with one another (e.g., messages may be transmitted between business systems 210-260) and/or may query catalog system 205.

Catalog system 205 may include one or more computing devices that implement a centralized catalog of the products that are offered by the business. Catalog system 205 may maintain a model of the products that are offered by the business. For example, each product may be associated with a specification (e.g., a list of attribute-value pairs) that defines the values associated with properties of the product. Catalog system 205 may also include groupings of different products into predefined “solutions”. A solution may itself be associated with a specification. In some implementations, pricing information may be included in the model of a product.

In some implementations, the product models in catalog system 205 may be associated with rules that may be used to define product availability information, cost information, dependence information, or other information relating to the products of the business. For example, catalog system 205 may support rules relating to: availability of products; dependency combinations relating to the products; country-legal entity information; product country availability; mutually exclusive products; and/or charging and compensation.

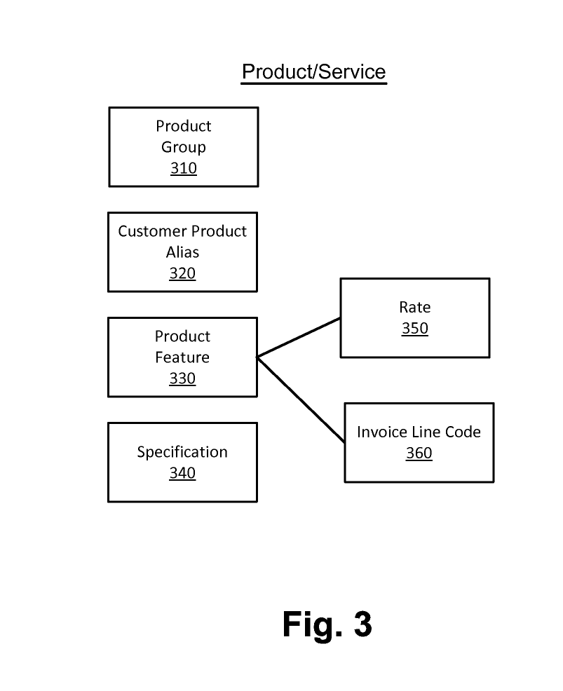

FIG. 3 is a diagram conceptually illustrating an example of relationships of elements used in the modeling of products in product catalog system 205. As illustrated, a model of a particular product, as modeled in catalog system 205, may include product group 310, customer product alias 320, product feature 330, specification 340, rate 350, and invoice line code 360.

Product group 310 may include information, in a model of a product, that indicates how a particular product can be grouped with other products. The grouping may be used, for example, for filtering, browsing, and reporting purposes relating to catalog system 205. For example, for a telecommunications company, products may be associated with product groups such as “networking services,” “storage services,” etc.

Certain products may be rebranded or renamed to customer specific labels and/or descriptions. Customer product alias 320 may include information, relating to a particular product, that defines whether the particular product has been rebranded and information relating to the rebranding.

Product feature 330 may include information indicating the features of a particular product. Features of a particular product may include, for example, one or more predefined feature codes that indicate the functionality of the product. For example, a network router product may be associated with feature codes that indicate that the product is a networking product and a routing product. As another example, a managed local area network (LAN) product (e.g., a service in which the business manages a LAN for a customer) may be associated with the features “monitor routing function,” “monitor switching function”, and “monitor LAN optimization.” Some of the features may be optional features. For instance, in the previous example, the feature “monitor LAN optimization” may be an optional feature, in which customers may choose whether the business that provides the managed LAN will also monitor the LAN to potentially optimize the operation of the LAN.

Specification 340 may include one or more attribute-value pairs that may be used to define and configure a product or a feature relating to a product. For a product relating to the providing of a private network, for example, specification 340 may include attributes such as “wireless” and “encrypted network links” which may be associated with values indicating whether the network includes wireless links and a value indicating whether traffic over the network links is encrypted.

Rate 350 may include information indicating how the price of a particular product is to be determined. For example, for a particular product, rate 350 may include an indication of the factors and determine the final price of the product. For a networking product, for instance, rate 350 may indicate that the bandwidth of a networking product, the location of the networking product, and the quality of service guaranteed by the networking product may all be determinants that should be taken into account when determining the final price of the networking product.

Invoice line code 360, for a particular product, may be a code that represents a unique combination of product features and price impacting specifications to present on a customer's invoice with a specific charge to the customer.

Referring back to FIG. 2, sales initiation system 210 may include one or more computing devices that implement customer relationship management software to help model a business's interaction with current and future customers. Salespeople, associated with the business, may use sales initiation system 210 to initiate sales opportunities and to submit product quotes and view available products and services.

Sales initiation system 210 may, for example, based on input from the salesperson, query catalog system 205 to identify products, services, and solutions that may be appropriate for a potential customer. The salesperson may review the obtained products, services, and/or solutions, and potentially after meeting with the potential customer, request a quote from pricing/quoting system 220.

Pricing/quoting system 220 may include one or more computing devices that perform operations, potentially with input from workers, relating to the generation of pricing or quoting information relating to a sale or potential sale. In response to a quote request, from a salesperson, pricing/quoting system 220 may include logic to automatically determine prices, or a range of potential prices, for a particular combination of products and services. The operation of pricing/quoting system 220 may be based on a number of business rules and/or models that allow for the pricing of complex combinations of products and services.

In some implementations, pricing/quoting system 220 may additionally determine the legal entity, such as a legal entity tracked by the business, corresponding to the potential customer. Pricing/quoting system 220 may generate a message, for a worker associated with pricing/quoting system 220, to verify the customer and/or to validate other information associated with the customer (e.g., customer billing address, customer full address, creditworthiness of the customer, etc.). For example, pricing/quoting system 220 may present an interface, to the worker, requesting that the worker verify the customer. The interface may be pre-populated with information that is known, by the business, about the customer (e.g., information obtained from sales initiation system 210). In this manner, relevant information may be automatically presented, to the responsible worker, that may assist the responsible worker in efficiently perform the verification of the customer.

Other operations may be initiated and/or performed with respect to pricing/quoting system 220. For example, for products relating to network services, a worker specializing in network architecture, such as a network technician, may be automatically assigned the task of reviewing the products to verify that the solution embodied in the products is technically feasible and/or optimal. In some implementations, the network technician may make or suggest changes to the offered products. As another example of an operation that may be performed by pricing/quoting system 220, pricing/quoting system 220 may apply rules to ensure that the offered products do not violate export laws, federal or state regulations, or other relevant laws/regulations. For example, a rule may specify that certain products are not permitted to be sold in certain geographic locations.

Contracting system 230 may include one or more computing devices that perform operations relating to the establishment and signing of contracts relating to the sale of products of the business. A contract relating to a sale of products may define the terms of the agreement between the business and the customer including, for example, the length of the agreement, the particular products that are being provided, and/or billing terms.

The creation of a contact may be initiated, for example, by a salesperson, through sales initiation system 210, in response to the salesperson and the customer coming to a tentative agreement on the products that the customer like to purchase from the business. Sales initiation system 210 may send a message to contracting system 230, indicating that a new contract is to be created. In response, contracting system 230 may initiate one or more tasks, such as a credit check of the customer. Contracting system 230 may generate a task, for a worker, relating to generation of the contract. For example, a worker may be given the task of preparing the contract and may be presented with information relating to the customer (e.g., the result of the credit check and customer information from sales initiation system 210) and pricing information determined by pricing/quoting system 220.

In one implementation, contracting system 230 may use rules to determine which particular worker to assign tasks relating to contract creation. For example, contracting system 230 may receive or store information indicating that certain workers have experience with certain customers, products, or types of contracts. Contracting system 230 may use rules to automatically match the task, relating to contract creation, to a worker that has experience that most closely matches that required for the contract. In one implementation, worker workload may also be taken into account by pricing/quoting system 220 when matching a worker to a contract (e.g., workers that are associated with a low workload may be given priority over workers associated with a high workload).

In some implementations, contracting system 230 may assist the worker in creating the contract by providing template language for the worker. For example, certain products may be associated with particular standard contract language. Contracting system 230 may use the products that are the subject of the sale to look up relevant contract language and/or suggest contract language to the worker. Alternatively or additionally, a worker may enter information relating to the contract, such as if the contract is a new contract or an alteration of a previous contract. Contracting system 230 may also use this information in generating a draft contract and/or in providing the worker with contract language.

When the worker or workers associated with contracting system 230 approve a final version of the contract, the salesperson associated with the sale may be notified, such as via a message to sales initiation system 210, to present the final version of the contract to the customer. Customer revisions or requests to modify the contract may be similarly transmitted back to contracting system 230 for consideration by contracting system 230 and/or the workers associated with contracting system 230. After customer signature of a contract, the signed contract may be stored, such as by contracting system 230, and assigned a contract identifier value. Contracting system 230 may transmit an indication of the signed contract to one or more other systems of business systems 200 (e.g., order management system 240, provisioning system 250, and/or billing system 260).

Order management system 240 may include one or more computing devices that perform operations, potentially based on input from workers, relating to initiation of fulfillment of the products associated with the contract. Processing by order management system 240 may be performed in response to a message from contracting system 230 indicating that a contract has been signed. For example, order management system 240 may present the agreed-upon products, associated with the contract, to an account manager, who may initiate the order(s) relating to the products. In some implementations, the particular account manager may be automatically selected, by order management system 240, based on the type of products that are associated with the contract (e.g., the account manager may be chosen that is responsible or experienced in the products that are the subject of the contract).

The account manager may, for example, enter customer due dates and target dates. The account manager, or other workers associated with order management system 240, may provide other relevant information relating to fulfillment of the products corresponding to the contract, such as network circuit information (e.g., for a contract relating to network services), design/product parameters that were discussed by the salesperson, information identifying relevant departments technicians that may be responsible for provisioning of the products, information that needs to be gathered before the contracted products can be delivered, or other information.

Provisioning system 250 may include one or more computing devices that perform operations, potentially with input from workers, relating to the fulfillment of products that have been purchased by a customer. In one implementation, after processing by order management system 240, order management system 240 may send a message to provisioning system 250 to initiate provisioning relating to the products that are the subject of the contract. Provisioning system 250 may break the order for the products into parts based on the resources required for each part of the order. Multiple products in an order may thus be simultaneously processed by provisioning system 250.

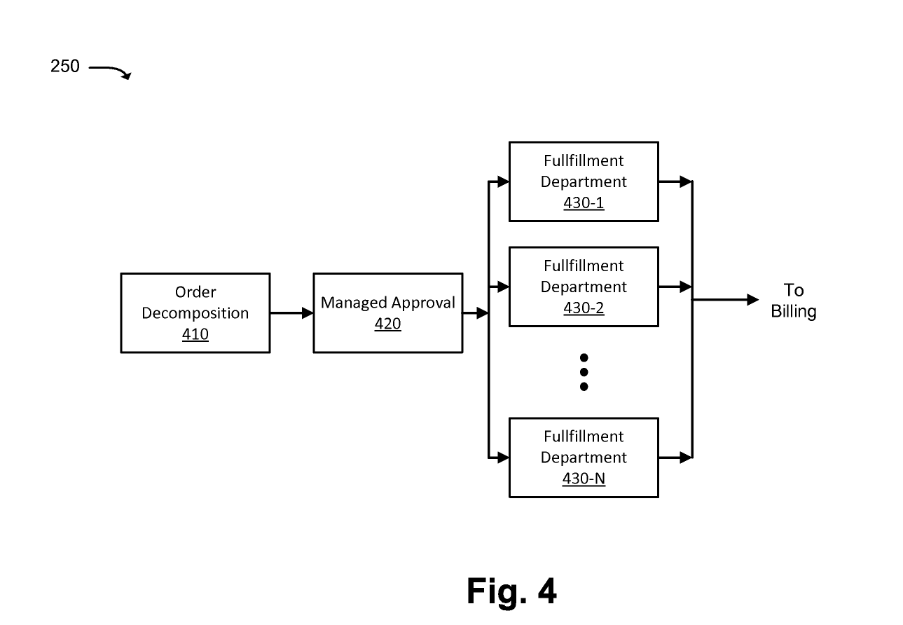

FIG. 4 is a block diagram conceptually illustrating an example of components of provisioning system 250. Provisioning system 250 may include order decomposition component 410, managed approval component 420, and a number of fulfillment departments 430-1 through 430-N (N>=1).

Order decomposition component 410 may include one or more computing devices that perform operations, potentially with input from workers, relating to splitting an order (e.g., an order corresponding to the products in finalized contract) into a number of constituent work orders. Each constituent work order may correspond to an order that can be handled by a particular department (or other unit) of the business. For example, for a telecommunications company, an order for network services may be associated with provisioning that needs to performed at the edge of a core (e.g., backbone network) network of the company and provisioning that needs be performed at the customer premises. Different department/divisions of the telecommunications company may be responsible for these different components of the provisioning.

In one implementation, order decomposition component 410 may generally perform functions relating to reviewing an order, determining the relevant fulfillment departments 430 for the order, and creating a number of work orders (sub-orders) based on the order. Ideally, each work order should correspond to a particular fulfillment department 430. In one implementation, order decomposition component 410 may generate one or more order forms based on an automated analysis of the products that are included in the order. The automated analysis may include using catalog system 205 to determine departments 430 that are associated with the various products associated with the order. In some implementations, a worker may validate the automatically generated order forms and/or revise the automatically generated order forms.

Managed approval component 420 may include one or more computing devices that perform operations, potentially with input from workers, relating to final review and approval of orders generated by order decomposition component 410. In one implementation, each order generated by order decomposition component 410 may be automatically routed (e.g., emailed or otherwise notified) to a worker that specializes in the department 430 associated with the order. The worker, in the associated department 430, may perform a final review of the order. When the worker indicates the order is accepted, the order may automatically be transmitted to the appropriate fulfillment department 430.

Fulfillment departments 430, as previously mentioned, may each correspond to a department, unit, or other entity associated with a business, in which each fulfillment department 430 may be responsible for the fulfillment of orders for a particular set of products. For example, a telecommunications company may include fulfillment departments 430 relating to: network equipment, access networks, private Internet Protocol (IP) networks, company provider edge systems, and managed networks. Each fulfillment department 430 may include one or more computing systems to manage of operation of the fulfillment department. After a particular order is completed by a fulfillment department 430, the completion of the order may be automatically reported back to order management system 240 and/or to billing system 260.

Billing system 260 may include one or more computing devices that perform operations, potentially with input from workers, relating to customer billing. Billing may be initiated based on completion of provisioning by provisioning system 250. At each billing interval assigned to a particular customer, billing system 260 may calculate the amount to bill the customer. In one implementation, billing system 260 may determine billing values based on rate information obtained from pricing/quoting system 220 and/or from catalog system 205. Additionally, some products provided by the business may be billed based on an amount of usage by the customer (metered model). For these types of products, billing system 260 may receive usage information relating to the products and determine billing amounts based on the received usage information. Billing system 260 may additionally include revenue accounting and reporting systems, including, for example, systems to perform revenue recognition and reporting.

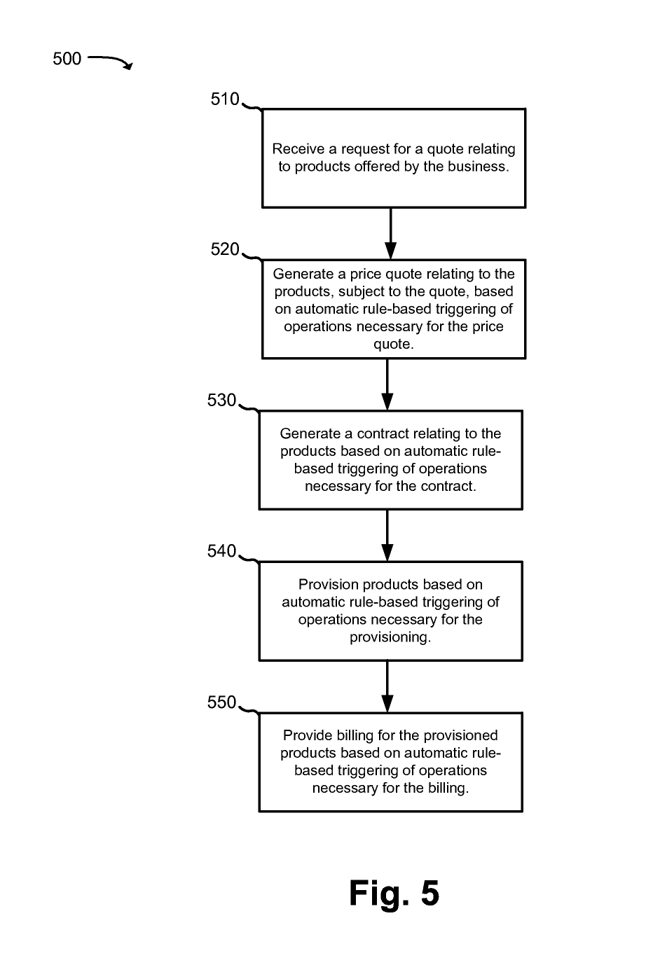

FIG. 5 is a flow chart illustrating an example of a process 500 that may performed to coordinate the operation of business systems. The operations shown in FIG. 5 may be performed, for example, by business systems 200. In some implementations, coordination between the various systems, within business systems 200, may be performed using a decentralized message passing technique implemented via rules configured at the individual systems within business systems 200.

Process 500 may include receiving a request for a quote relating to products offered by the business (block 510). As mentioned previously, the request for a quote may be initiated by a salesperson, via sales initiation system 210, to pricing/quoting system 220. The request for the quote may be initiated based on products that the salesperson has identified as being desirable by the customer.

Process 500 may further include generating a price quote relating to the products, identified in the request for the quote (block 520). The price quote may be based on automatic rule-based triggering of operations necessary to obtain the price quote (block 520). For example, pricing/quoting system 220 may look up pricing rules in catalog system 205 and/or use pricing rules maintained by pricing/quoting system 220 to obtain a price quote for the products associated with the request for a quote. In general, pricing/quoting system 220 may use a number of business rules and/or models that allow for the pricing of complex combinations of products and services. In one implementation, pricing/quoting system 220 may return a range of acceptable prices to the salesperson. The salesperson may use the range when negotiating with the potential customer. In some implementations, pricing/quoting system 220 may operate entirely automatically to generate a price quote. Alternatively or additionally, certain pricing decisions may require input from a worker. When these pricing decisions are received by pricing/quoting system 220, the worker may be notified and prompted for input.

Process 500 may further include generating a contract relating to the products (block 530). The contract may be based, at least in part, on automatic rule-based triggering of operations necessary for the price quote (block 530). For example, in response to an indication, such as a message initiated by a salesperson, that a previous price quote has been tentatively agreed upon by a customer, contracting system 230 may initiate a credit check of the customer and/or perform other automated checks relating to the contract or the customer. As previously mentioned, contracting system 230 may automatically determine and assign a task, relating to contract creation, to one or more workers. The worker, such as a worker in the legal department of the business, in response to the task notification, may be provided with one or more contract templates or with other information, such as the price quote or notes from the salesperson, that will assist the worker in the creation of the contract.

Process 500 may further include provisioning products based on automatic rule-based triggering of operations necessary for the provisioning (block 540). For example, order management system 240 and/or provisioning system 250 may determine one or more work orders corresponding to a contract; may request, from a worker, approval of the work orders; and may dispatch the work orders for fulfillment. Provisioning system 250 may additionally receive indications of fulfillment of the work orders and may transmit messages to billing system 260 to indicate when a contract is ready for billing.

Process 500 may further include providing billing for the provisioned products based on automatic rule-based triggering of operations necessary for the billing (block 550). For example, as previously discussed, billing system 260 may determine billing values based on rate information obtained from pricing/quoting system 220 and/or from catalog system 205. For metered products, billing system 260 may determine billing amounts based on the usage information that is received for the metered products.

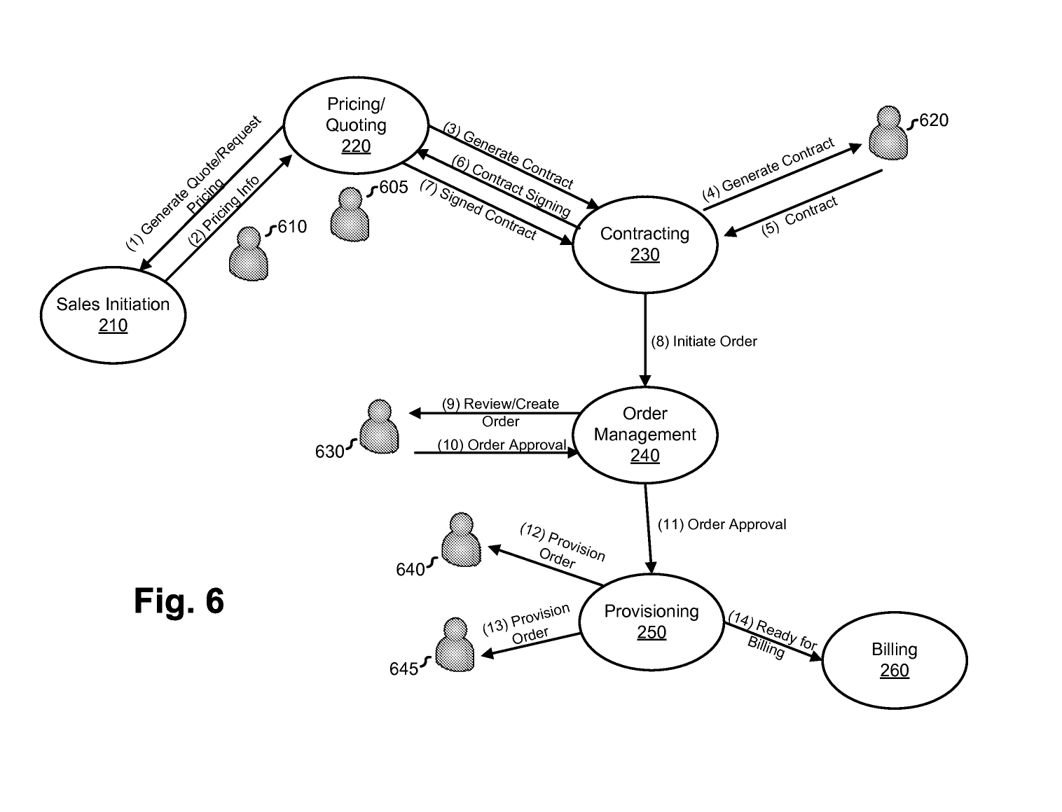

FIG. 6 is a diagram conceptually illustrating an example of communications between various systems of business system 200. The communications shown in FIG. 6 represent one possible example of communications between the constituent systems of business system 200. The communications shown in FIG. 6 may generally illustrate decentralized and automated coordination between business systems to implement the sale and fulfillment of products provided by a business. In FIG. 6, communications are particularly illustrated between sales initiation system 210, contracting system 230, order management system 240, and provisioning system 250.

As shown in FIG. 6, assume that a salesperson 610 would like to pursue a sales opportunity with a potential customer. Salesperson 610 may discuss potential products, with the customer, and may request, via sales initiation system 210, a quote and/or pricing information (message (1), Generate Quote/Request Pricing). In response, pricing/quoting system 220 may generate a request and/or pricing information, such as a quote that is generated after review by a margin analysis team 605. In some implementations, margin analysis team 605 may be automatically involved only for certain quote requests (e.g., quote requests over a threshold value, quote requests for certain potential customers, quote requests for certain products, etc.). The pricing information may be transmitted back to salesperson 610, via sales initiation system 210 (message (2), Pricing Info). Salesperson 610, based on the pricing information, may agree upon terms of the contract with the potential customer. Through sales initiation system 210, salesperson 610 may indicate that a signed contract is needed to complete the sale. In response, sales initiation system 210, via pricing/quoting system 220, may transmit a message (message (3), Generate Contract), to contracting system 230, indicating that a contract is needed. Contracting system 230 may assign the task, relating to the contract creation, to one or more workers 620 associated with contracting system 230 (message (4), Generate Contract). In some implementations, when assigning the contract task, contracting system 230 may determine the type of contract that is likely to be needed, determine a suitable worker 620 to create the contract, and provide worker 620 with one or more contract templates or other information that is likely to be relevant to the worker in creating the contract.

When the worker indicates that the contract is complete (message (5), Contract), contracting system 230 may store the contract and send a message to salesperson 610 indicating that the contract is ready for signing (message (6), Contract Signing). Salesperson 610 may obtain, from the customer, a signed version of the contract and provide the signed version of the contract to contracting system 230 (e.g., salesperson 610 may scan or otherwise upload a copy of the signed contract; message (7), Signed Contract). Contracting system 230, in response to receiving the finalized version of the contract, may initiate an order for fulfillment of the products corresponding to the contract (message (8), Initiate Order). The message to initiate the order may be transmitted to, for example, order management system 240.

Order management system 240, in response to receipt of the message to initiate the order, may present the agreed-upon products, associated with the contract, to account manager 630 (message (9), Review/Create Order). Account manager 630 may initiate the order(s) relating to the products. As previously mentioned, account manager 630 may provide information relevant to the completion or fulfillment of the products related to the contract (e.g., target dates, design/product parameters etc.). Account manager 630 may then indicate approval of an order (message (10), Order Approval). Order management system 240 may transmit the order approval message to provisioning system 250 (message (11), Order Approval).

Provisioning system 250, in response to receipt of the order approval message, may initiate provisioning of the order. As previously mentioned, provisioning system 250 may break an order into one or more work orders based on an analysis of the products that are included in the order. The analysis may include using catalog 205 to determine departments 430 that are associated with the various products associated with the order. Provisioning system 250 may send messages to individual departments of the business assigned to handle each of the work orders (messages (12) and (13), Provision Order). As illustrated in FIG. 6, a first work order may be received by a first technician 640 (e.g., associated with a first department) and a second work order may be received by a second technician 645 (e.g., associated with a second department). After the provisioning by each department, a message may be sent back to provisioning system 250 to indicate the completion of the work order. In response to receipt of all of messages indicating all of the provisioning for an order is complete, provisioning system may signal billing system 260 to initiate customer billing (message 14, Ready for Billing).

In the example discussed with respect to FIG. 6, number of business systems are tied together to form a decentralized and automatic workflow by which various workers and systems, involved in the workflow, are automatically assigned tasks based on the state of the workflow. When possible, when providing a task to a particular worker, information relevant to the task may also be provided to the worker, which may potentially minimize rekeying data, by the workers, and allow the workers more efficiently perform their assigned tasks.

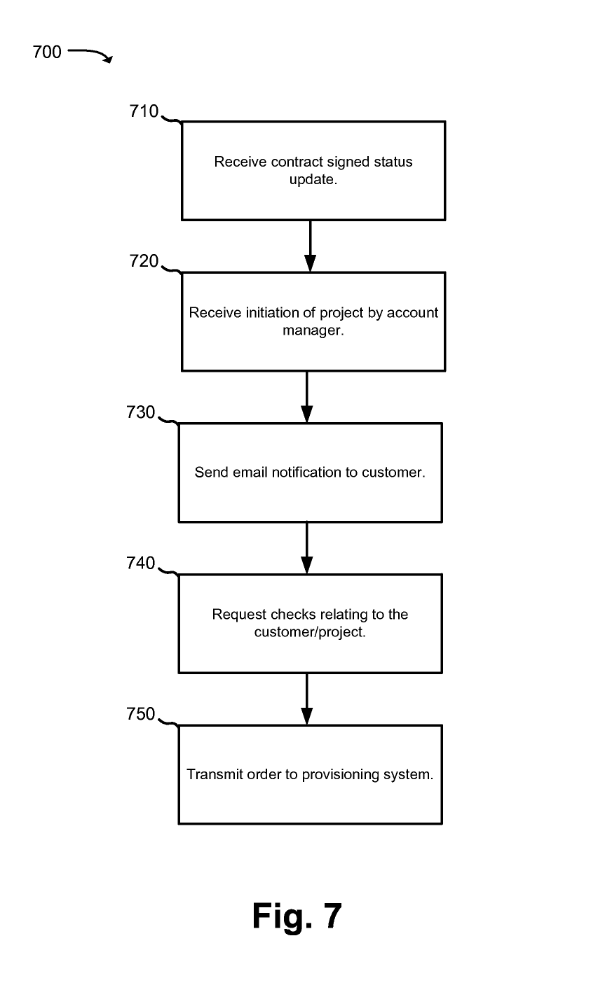

FIG. 7 is a flow chart illustrating an example of a process 700 that may performed by order management system 240. In this example, process 700 may be a process performed when the business includes a telecommunications company that provides network services to customers.

Process 700 may include receiving an indication that a contract, relating to products provided by the business, is signed (block 710). As previously mentioned, the indication may be received from contracting system 230. In response to the signed contract, an account manager may be notified to review and initiate the project corresponding to the contract. Process 700 may further include receiving an indication, from the account manager, that the project is initiated (block 720).

Process 700 may further include transmitting an email notification to the customer (block 730). The email notification may inform the customer that the project, relating to the contract, has been initiated. The email notification may include additional information, such as important dates, verification of details relating to the project, or other information.

Process 700 may further include requesting checks relating to the customer and/or the project (block 740). For example, order management system 240 may request a credit check of the customer, an export compliance check relating to the project, or other checks. In one implementation, the credit check may automatically be performed using a third-party system (e.g., a credit monitoring entity). The export compliance check may be performed by order management system 240 (or by a subsystem corresponding to order management system 240) using, for example, a number of predetermined export compliance rules (e.g., certain products may not be installable for customers located in certain jurisdictions). Process 700 may further include transmitting the order to the provisioning system (block 750) for completion.

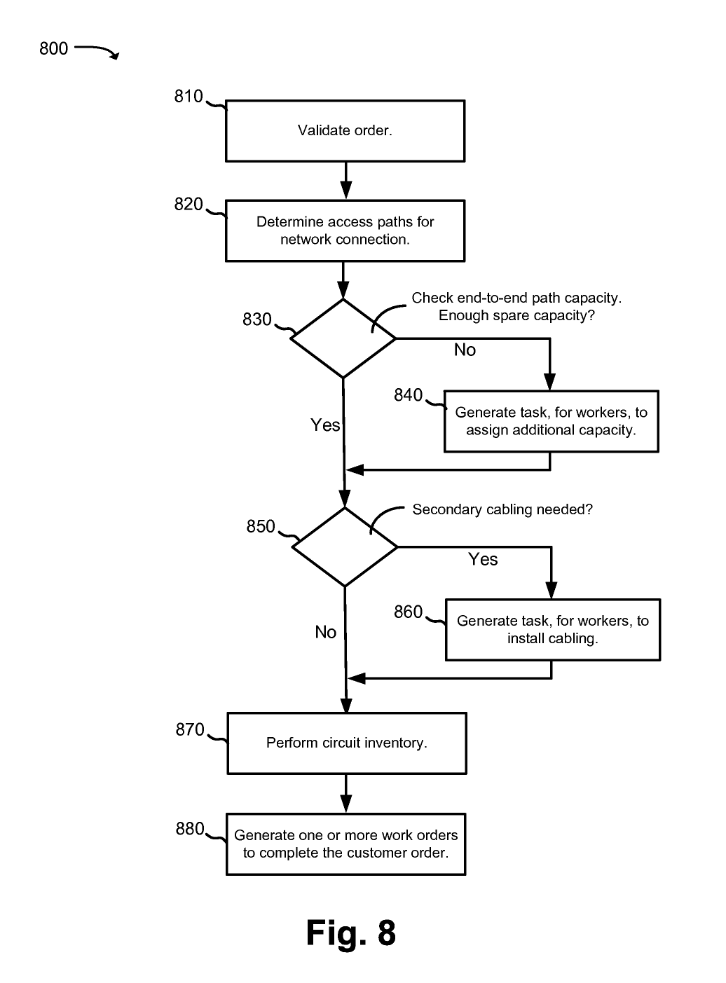

FIG. 8 is a flow chart illustrating an example of a process 800 that may be performed by provisioning system 250. In this example, process 800 may be a process performed when the business includes a telecommunications company that provides network services to customers.

Process 800 may include validating an order (block 810). In one implementation, validation may be a manual task, performed by one or more workers associated with provisioning system 250. Provisioning system may generate a validation task and transmit the task to a worker. The worker may examine the order do determine that it is technically feasible, and may transmit a response to provisioning system 250 that indicates whether the order was validated. In this implementation, the validation may thus include transmitting the validation order, to a worker, and receiving a response from the worker.

Process 800 may further include determining access paths for network connections relating to the order (block 820). For example, provisioning system 250 may analyze network paths that may be used to satisfy the order and determine optimal network paths for the order. The analysis of the network paths and the determination of the optimal network paths may be based on one or more models or rules relating to the network maintained by the business.

Process 800 may further include checking the end-to-end path capacity, corresponding to the determined access paths for the network connections, and determining whether the network includes enough spare capacity on the determined access paths (block 830). The determination of whether enough spare capacity exists on the determined access paths may be made based on, for example, an analysis of the capacity of network links in the network relative to capacity of the links that is already committed to other customers.

When it is determined that not enough spare capacity exists, (block 830—No), provisioning system 250 may generate a task, for one or more workers, to assign or otherwise create additional capacity for the determined access paths in the network (block 840).

Process 800 may further include determining whether additional (secondary) cabling is needed (block 850). For example, additional cabling (e.g., coaxial or fiber lines) may be needed at the customer premises, between the customer premises and a connection node in the network managed by the business, or at another point in the network. When it is determined that secondary cabling is needed (block 850—YES), provisioning system is generated task, one or more workers, to install the additional cabling (block 860).

Process 800 may further include performing a circuit inventory (block 870). For example, provisioning system 250 may determine the network devices (e.g., routers and switches) that may need to be configured to implement the access paths that are needed for the order. Provisioning system 250 may additionally make any configuration changes needed to enable network routing that is used to implement the access paths.

Process 800 may further include generating one or more work orders to complete the customer order (block 880). The work orders may generally relate to additional changes to the network, which may need to be performed by network technicians, in complete the customer's order.

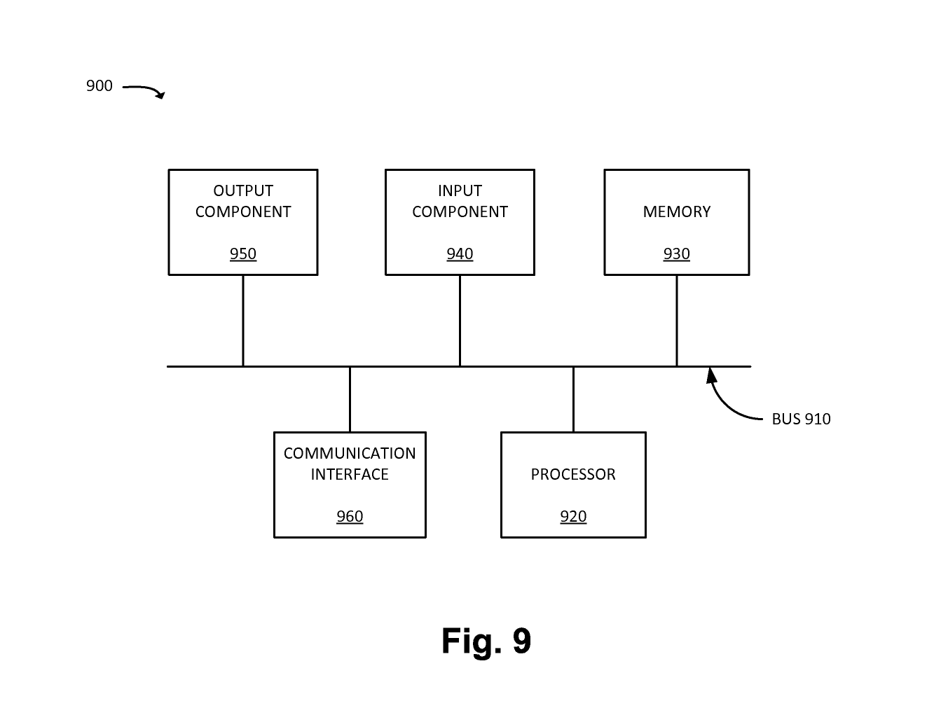

FIG. 9 is a diagram of example components of a device 900. Each of the devices illustrated in FIGS. 1-4 and 6 may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. Memory 930 may include any type of dynamic storage device that may store information and instructions for execution by processor 920, and/or any type of non-volatile storage device that may store information for use by processor 920.

Input component 940 may include a mechanism that permits an operator to input information to device 900, such as a keyboard, a keypad, a button, a switch, etc. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (“IR”) receiver, a Bluetooth radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while series of blocks have been described with regard to FIGS. 5, 7, and 8, the order of the blocks may be modified in other implementations. Further, non-dependent blocks may be performed in parallel. Additionally, while example signals are shown in FIGS. 1, 3, 4, and 6, other signals may be sent and/or received before and/or after the signals shown in these figures, in other implementations.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as “logic” that performs one or more functions. This logic may include hardware, such as an ASIC or a FPGA, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A system comprising:
one or more computing devices to implement a contracting system to:
receive a request for a contract relating to products and services offered by a business,
determine one or more workers to generate the contract,
transmit a message, to the one or more workers, indicating that the one or more workers are to generate the contract,
receive a generated contract from the one or more workers, the generated contract being generated based on the message indicating that the one or more workers are to generate the contract,
forward the generated contract for signature, and
transmit, in response to reception of a signed version of the contract, a message initiating order fulfillment for the products and services to which the contract relates; and
one or more computing devices to implement a provisioning system to:
determine, as part of the order fulfillment, a plurality of work orders corresponding to the products and services to which the contract relates, and
issue the plurality of work orders to a plurality of provisioning departments of the business.

2. The system of claim 1, further comprising:
one or more computing devices to implement an order management system to:
receive the message initiating order fulfillment,
determine, based on the message initiating order fulfillment, one or more additional workers responsible for initiating orders for fulfillment of products and services, the one or more additional workers being determined based on a type of the products and services to which the contract relates, and
receive, from the one or more additional workers, an order for fulfillment of the products and services.

3. The system of claim 2, further comprising:
one or more computing devices to implement a pricing system to:
receive a request to determine pricing information associated with the products and services; and
determine the pricing information associated with the products and services.

4. The system of claim 3, further comprising:
a catalog system to maintain a model for each of the products and services offered by the business, the model for each of the products and services including pricing information and features associated with each of the products and services.

5. The system of claim 3, wherein the model for each of the products and services additionally includes a list of attribute-value pairs that define values for properties associated with each of the products and services.

6. The system of claim 1, further comprising:
one or more computing devices to implement a billing system to:
receive a message, from the provisioning system, indicating that provisioning of the products and services is complete, and
initiate, in response to the message, billing of a customer corresponding to the contract.

7. The system of claim 1, further comprising:
determining the one or more workers based on predetermined rules that match workers to contracts based on at least one of a type of contract required for the products and services, worker experience, or worker workload.

8. The system of claim 1, wherein the products and services include products and services relating to a telecommunications network.

9. A method implemented by one or more devices, the method comprising:
receiving, by the one or more devices, a request for a contract relating to products and services offered by a business;
determining, by the one or more devices, one or more workers to generate the contract;
transmitting, by the one or more devices, a message, to the one or more workers, indicating that the one or more workers are to generate the contract;
receiving, by the one or more devices, the generated contract from the one or more workers, the generated contract being generated based on the message indicating that the one or more workers are to generate the contract;
forwarding, by the one or more devices, the generated contract for signature;
transmitting, by the one or more devices and in response to reception of a signed version of the contract, a message initiating order fulfillment for the products and services to which the contract relates;
determining, by the one or more devices and as part of the order fulfillment, a plurality of work orders corresponding to the products and services to which the contract relates, and
issuing, by the one or more devices, the plurality of work orders to a plurality of provisioning departments of the business.

10. The method of claim 9, further comprising:
receiving the message initiating order fulfillment,
determining, based on the message initiating order fulfillment, one or more additional workers responsible for initiating orders for fulfillment of products and services, the one or more additional workers being determined based on a type of the products and services to which the contract relates, and
receiving, from the one or more additional workers, an order for fulfillment of the products and services.

11. The method of claim 10, further comprising:
receiving a request to determine pricing information associated with the products and services; and
determining the pricing information associated with the products and services.

12. The method of claim 10, further comprising:
receiving a message indicating that provisioning of the products and services is complete, and
initiating, in response to the message, billing of a customer corresponding to the contract.

13. The method of claim 9, further comprising:
maintaining a model for each of the products and services offered by the business, the model for each of the products and services including pricing information and features associated with each of the products and services.

14. The method of claim 9, wherein the products and services include products and services relating to a telecommunications network.

15. A method implemented by one or more computing devices, the method comprising:
receiving, by the one or more computing devices, a request for a contract relating to products and services offered by a business;
generating, by the one or more computing devices, a first message indicating preparation of the contract is needed by a worker associated with the business;
receiving, by the one or more computing devices and from the worker, a prepared version of the contract;
determining, by the one or more computing devices and in response to reception of a signed version of the contract, a plurality of departments, associated with the business;
transmitting, by the one or more computing devices, at least one work order, to each of the plurality of departments, to initiate provisioning of the products and services corresponding to the contract;
receiving, by the one or more computing devices, second messages indicating completion of performance of the provisioning of the products and services corresponding to the contract; and
initiating, by the one or more computing devices, and based on the reception of the second messages indicating the completion of performance of the provisioning, billing of a customer corresponding to the contract.

16. The method of claim 15, wherein the first message is associated with first information relating to the customer and second information relating to the products and services offered by a business, the first and second information being provided to the worker to enable preparation of the contract.

17. The method of claim 15, wherein pricing information for the contract is received from a catalog that models each of the products and services offered by the business.

18. The method of claim 15, further comprising:
determining the first worker associated with the business based on predetermined rules that match workers to contracts based on at least one of a type of contract required for the products and services, worker experience, or worker workload.

19. The method of claim 15, further comprising:
receiving a request for a quote relating to the products and services; and
determining pricing information, in response to the request for the quote, based on pricing rules maintained in a catalog system for the business, wherein the pricing information includes a range of prices for the products and services at which a salesperson is authorized to agree upon.

20. The method of claim 15, wherein the products and services include products and services relating to a telecommunications network.
